(19) United States
(12) Patent Application Publication
(10) Pub. No.: US 2007/0008293 A1
(43) Pub. Date: Jan. 11, 2007

(54) TOUCH SENSITIVE DEVICE AND DISPLAY

(75) Inventor: Richard W. Oldrey, Clintondale, NY (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: INTERNATIONAL BUSINESS MACHINES CORPORATION, Armonk, NY (US)

(21) Appl. No.: 11/160,703

(22) Filed: Jul. 6, 2005

(51) Int. Cl. G09G 5/00

(52) U.S. Cl. 345/173

(57) ABSTRACT

Disclosed is a system that provides visual feedback to a user indicating which input components (e.g., keys, buttons, dials, etc.) of an input device (e.g., a keyboard, a keypad, a control panel, etc.) are currently being touched in order to avoid engaging the wrong input component. The system comprises a processor connected to both a touch-sensitive input device having a plurality of input components and a display. The touch-sensitive input device is adapted to detect when contact is made with any of the input components. The processor provides an image on the display that dynamically illustrates the input components that are currently being touched. The processor can further be adapted to allow the user to adjust size and/or location of the image on the display. Lastly, the processor can further be adapted to incorporate the image into an instructional application to be used as a teaching tool.

### BACKGROUND OF THE INVENTION

1. Field of the Invention

The invention generally relates to a touch-sensitive device, and, more particularly, to a system that provides feedback to a user indicating finger position on a touch-sensitive device.

2. Description of the Related Art

Keyboards (including keypads) are an integral input component in a number of different devices, such as laptop computers, desktop computers, typewriters, telephones, calculators, keyboard instruments, etc. Proper operation of such devices is dependent upon accurate finger positioning on the keyboard. Oftentimes low light conditions or a user's visual acuity may affect keyboard visibility. Backlighting beneath a keyboard or lights that plug into a keyboard or computer (e.g., into a USB port) may be used to proved lighting when ambient light is insufficient. However, such keyboard lighting requires additional hardware and power.

Also, whether typing or playing a keyboard instrument, keyboard use is more efficient if the user is not continuously looking down at the keyboard to confirm and adjust finger positioning. Similarly, when operating a vehicle, it is often necessary to simultaneously operate a telephone or some other device having a keypad or control panel (e.g., a radio, GPS, air conditioning unit, etc., in the dashboard of the vehicle.) Trying to operate the vehicle, while looking at the dashboard or at a telephone keypad to locate correct keys, buttons, or knobs raises safety concerns. Thus, there is a need for a device that can provide visual feedback to a user indicating finger positions, e.g., on a keyboard, on a keypad, on a control panel, etc.

### SUMMARY OF THE INVENTION

In view of the foregoing, an embodiment of the invention provides a system comprising a processor in communication with both a touch-sensitive input device and a display. The input device can comprise any type of electronic input device, such as a keypad, a typing keyboard (e.g., a QWERTY keyboard), a musical keyboard instrument (e.g., a digital piano, a synthesizer, etc.) or a control panel (e.g., a control panel for a stereo, air conditioning unit, GPS, etc.). Specifically, the input device can comprise a plurality of input components (e.g., keys, buttons, dials, knobs, etc.) and can be adapted to detect when any of these input components are touched. More specifically, the input device can be adapted to detect when any of the input components are touched but not yet engaged (e.g., pressed, turned, pulled, etc.). For example, the input device can comprise touch-sensitive input components in which each input component has a sensor adapted to detect when a finger contacts that corresponding input component. The input device can also be adapted to dynamically convey to the processor an indication as to which of the input components are currently being touched by a user. The processor is adapted (e.g., using software) to dynamically provide an image on the display that identifies the touched input components. The display can be any form of digital display, for example, a display screen on a computer monitor or a heads-up display (HUD) on the windshield of a vehicle. The image can comprise, for example, an illustration of the individual input components as they are touched. Alternatively, the image can comprise an illustration of the input device itself (e.g., an illustration of the keyboard, keypad or control panel) that highlights the individual input components (e.g., keys or buttons) that are currently being touched by contrasting them with other input components on the input device in some manner (e.g., by providing a bold outline around the key, by displaying the touched keys in a different color than the other keys on the keyboard, etc.). Additionally, the processor can be adapted to allow a user to adjust the size and/or the location of the image on the display.

This system is particularly useful in providing feedback to a user when the user's visibility of the input device is limited due to either the user's lack of visual acuity or reduced ambient lighting conditions surrounding the input device. Additionally, this system can be useful in providing feedback to a user when a user does not wish to focus attention on the input device (e.g., when typing, reading music, driving a vehicle, etc).

In another embodiment of the invention, the processor can also be configured with an instructional application (e.g., software designed to teach a user to type or play a piano, as applicable) and the image on the display can incorporated into the instructional application to be used as a teaching tool. For example, the processor can be adapted to provide an image on the display that identifies not only the touched keys of a typing or musical keyboard, as described above, but also one or more select keys on the keyboard. The select keys can indicate either the next keystroke (i.e., the next key which should be pressed) or can indicate a proper starting position for the user's fingers on the keyboard. The processor can be adapted to contrast the touched keys from the select keys (e.g., by highlighting the touched and selected keys in a different manner, by displaying the touched keys and selected keys in different colors, etc.).

An embodiment of the method of the invention for providing visual feedback to a user indicating finger positions on an input device (e.g., a keypad, a keyboard or a control panel) comprises detecting touched, non-engaged input components (e.g., buttons, keys, dials, etc.) on the input device; and, dynamically displaying on a display an image that identifies the touched, non-engaged input components. For example, an image can be displayed that includes an illustration identifying only the touched input components or an illustration of the input device itself that contrasts (e.g., by color, bold outlines, highlighting, etc.) the touched, non-engaged input components with other input components, including touched, engaged input components. The method can further comprise varying the location and/or the size of the image on the display. Additionally, the method can comprise incorporating the image into an instruction application for example, for typing or digital piano instruction, as discussed above.

These and other aspects of embodiments of the invention will be better appreciated and understood when considered in conjunction with the following description and the accompanying drawings. It should be understood, however, that the following description, while indicating embodiments of the invention and numerous specific details thereof, is given by way of illustration and not of limitation. Many changes and modifications may be made within the scope of the embodiments of the invention without departing from the spirit thereof, and the invention includes all such modifications.

### BRIEF DESCRIPTION OF THE DRAWINGS

The embodiments of the invention will be better understood from the following detailed description with reference to the drawings, in which:

FIG. 1 illustrates a schematic diagram of an embodiment of the system of the invention;

FIG. 2 illustrates a schematic diagram of another embodiment of the system of the invention;

FIG. 3 illustrates a schematic diagram of another embodiment of the system of the invention;

FIG. 4 illustrates a schematic diagram of another embodiment of the system of the invention;

FIG. 5 illustrates a schematic diagram of another embodiment of the system of the invention; and

FIG. 6 illustrates a schematic flow diagram of an embodiment of a method of the invention.

### DETAILED DESCRIPTION OF PREFERRED EMBODIMENTS OF THE INVENTION

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the invention.

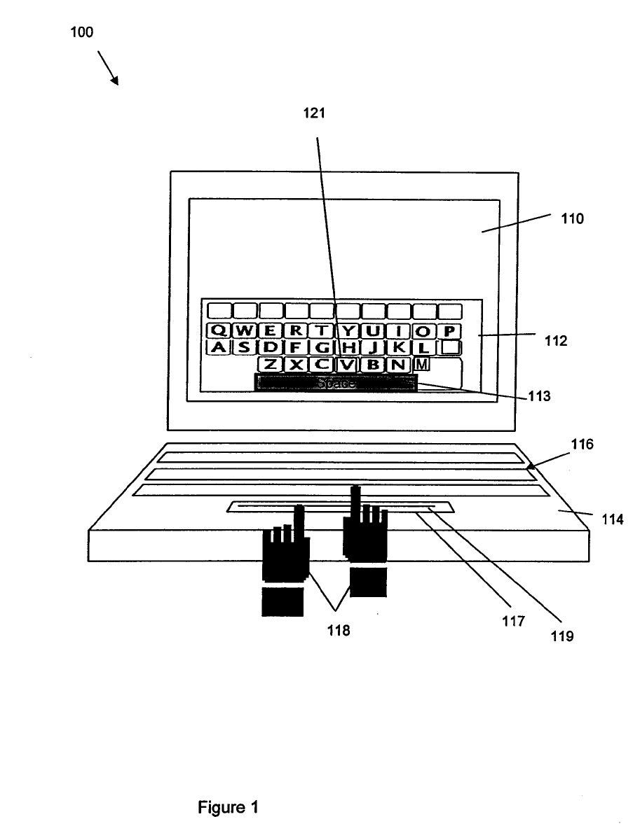

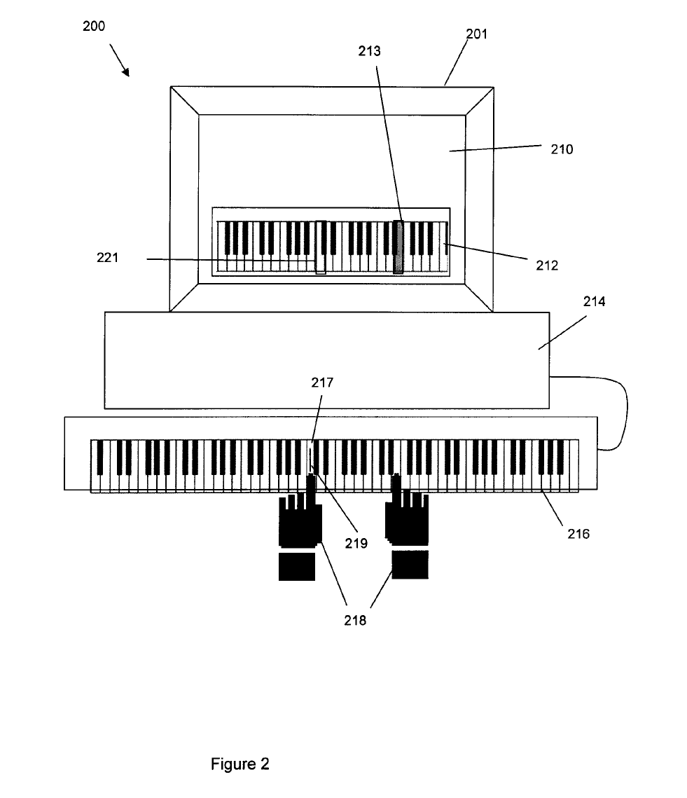

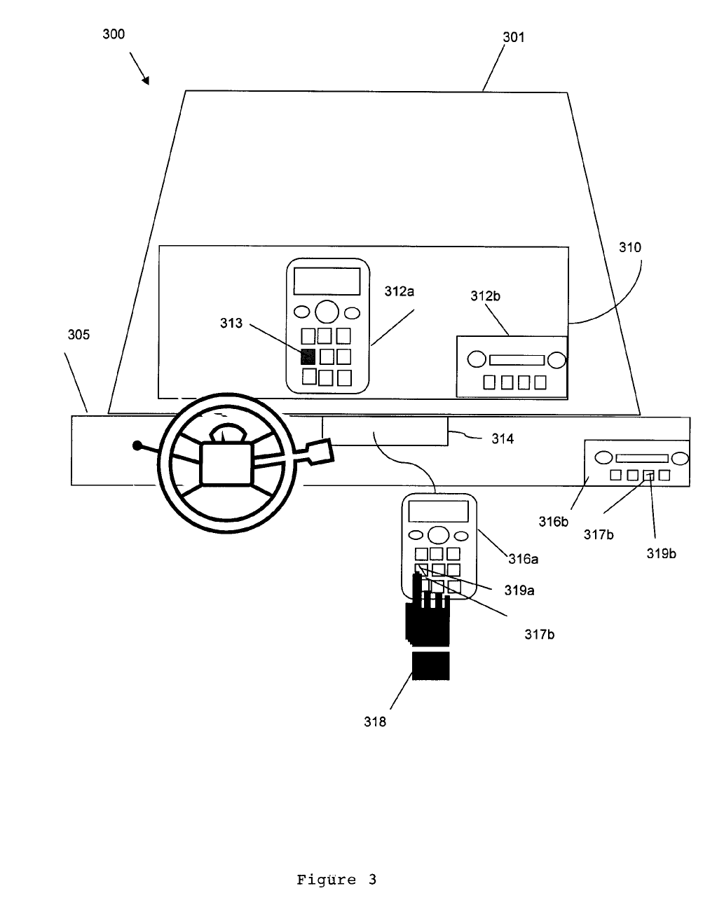

As mentioned above, there is a need for a system that can provide visual feedback to a user indicating which input components of an input device are being touched to avoid engaging the wrong input components. Such a system would be particularly useful in providing feedback to a user when the user's visibility of the input device is limited due to either the user's lack of visual acuity or reduced ambient lighting conditions surrounding the input device. Additionally, would be particularly useful in providing feedback to a user when a user does not wish to focus attention on the input device (e.g., when typing, reading music, driving a vehicle, etc). Referring to FIGS. 1-3, three exemplary embodiments of the system 100, 200, 300 of the invention are illustrated. FIG. 1 illustrates an exemplary embodiment of the system 100 in which a touch-sensitive computer keyboard 116 is incorporated into a computer having an internal processor 114. The internal processor 114 allows feedback from the keyboard 116 to be dynamically displayed on the display screen 110 indicating which keys 117 of the keyboard 116 are currently being touched. FIG. 2 illustrates an exemplary embodiment of the system 200 in which a touch-sensitive musical keyboard instrument 216 is connected to a separate processor 214 (e.g., a CPU of a desktop which is connected to a monitor 201). The separate processor 214 allows feedback from the keyboard 216 to be dynamically displayed on the display screen 210 indicating which key notes 217 of the keyboard 216 are currently being touched. FIG. 3 illustrates another exemplary embodiment of the system 300 in which a processor 314 is incorporated into a vehicle (e.g., into the dashboard 305). The processor 314 receives input from either external touch sensitive input devices 316a (e.g., a keypad or a control panel for a cell phone, GPS, etc. plugged into an input/output connector on the dashboard) or internal touch sensitive input devices 316b (e.g., a keypad or a control panel for a car stereo, GPS, air conditioning system, etc. located within the dashboard) and allows feedback from these input devices 316a-b to be dynamically displayed on a heads-up display (HUD) 310 on the windshield 301 of the vehicle to indicate which input components 317a-b of the input devices 316a-b are currently being touched.

More particularly, the input devices of the various embodiments of the system of the invention can comprise any type of electronic input device, such as a computer keyboard (e.g., a QWERTY keyboard 116 as illustrated in FIG. 1), a musical keyboard instrument (e.g., a digital piano keyboard 216 as illustrated in FIG. 2), a keypad (e.g., a cell phone keypad 316a as illustrated in FIG. 3) or a control panel (e.g., a stereo, GPS, air conditioning system, etc. control pad 316b as illustrated in FIG. 3). Referring to FIGS. 1-3, in each embodiment of the invention, the input device 116, 216, 316a and 316b is adapted to detect when any of its input components (i.e., keys, buttons, dials, etc.) are touched but not yet engaged (e.g., pressed, pushed, struck, turned, etc.). For example, the touch-sensitive input devices 116, 216, 316a and 316b can be realized by connecting to each input component 117, 217, 317a and b, a commercially available touch sensor 119, 219, 319a and b adapted to detect when a finger of a user 118, 218, 318 contacts that corresponding input component without engaging it. The input component 116, 216, 316a-b is also adapted to dynamically convey to the processor 114, 214, 314 an indication as to which of the input components are currently being touched and not engaged.

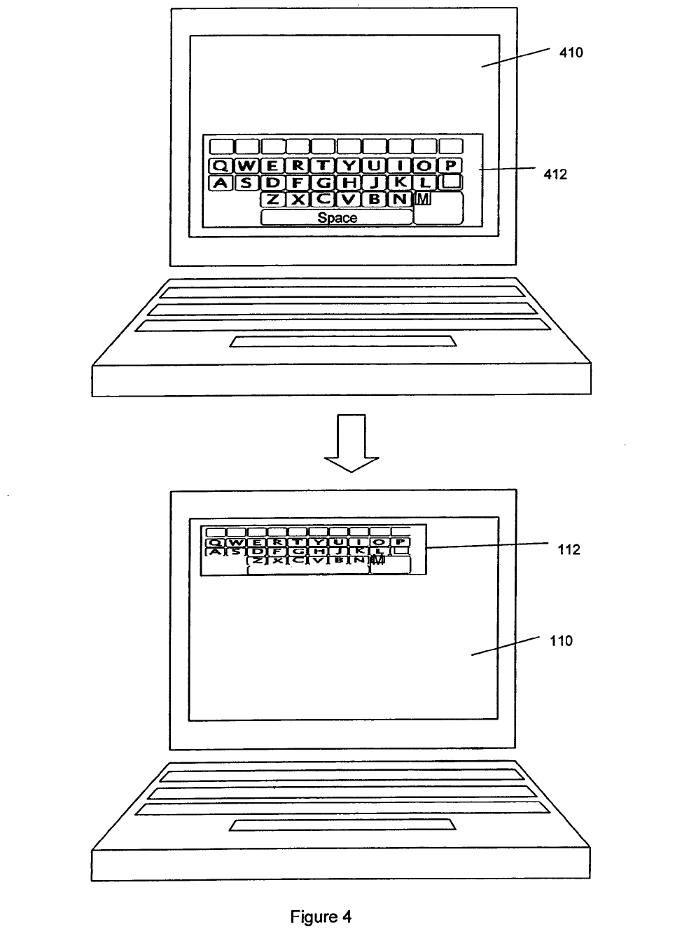

The processor can be integral part of the input device (e.g., see processor 114 of the laptop keyboard 116 of FIG. 1) or a separate unit (e.g., see the CPU 214 attached to the musical keyboard 216 of FIG. 2 or processor 314 of FIG. 3). The processor 114, 214, 314 can be adapted to dynamically form and transmit to a display 110, 210, 310 one or more images 112, 212, 312a-b, respectively, that identifies touched, non-engaged input components. The display 110, 210, 310 can comprise a display 110, 210 of a monitor 101, 201 as illustrated in FIGS. 1 and 2 or a heads-up display (HUD) 310 as illustrated in FIG. 3. The processor 114, 214, 314 can be configured with software that causes one or more images 112, 212, 312a-b to be displayed in a window of a display 110, 210, 310, respectively. The images 112, 212, 312a-b can comprise an illustration of individual input components touched, such as a letter key (e.g., M, N, O, etc.) touched on a typing keyboard, a note key (e.g., middle C) touched on a music keyboard, a number pushed on a cell phone, or a select key pushed on a radio. Alternatively, the images 112, 212, 312a-b can comprise illustrations of all or part of the input device 116, 216, 316a-b, respectively, such that touched, non-engaged input components 117, 217, 317a-b are highlighted by contrasting them with other input components on the input device in some manner. Highlighting the input components in an illustration of an input device can be accomplished by providing a bold outline around the touched, non-engaged input components (as illustrated by highlighted key 121 of image 112 of FIG. 1 and highlighted key 221 of image 212 of FIG. 2), by displaying the touched, non-engaged keys in a different color (as illustrated by colored key 113 of image 112 of FIG. 1 and colored key 213 of image 212 of FIG. 2), etc. The processor 114, 214, 314 may further be adapted to contrast (e.g., by color, outlines, etc.) touched, non-engaged input components with a touched, engaged input components. Additionally, referring to FIG. 4, the processor can be adapted to allow the user to vary the size and/or the location of the image.

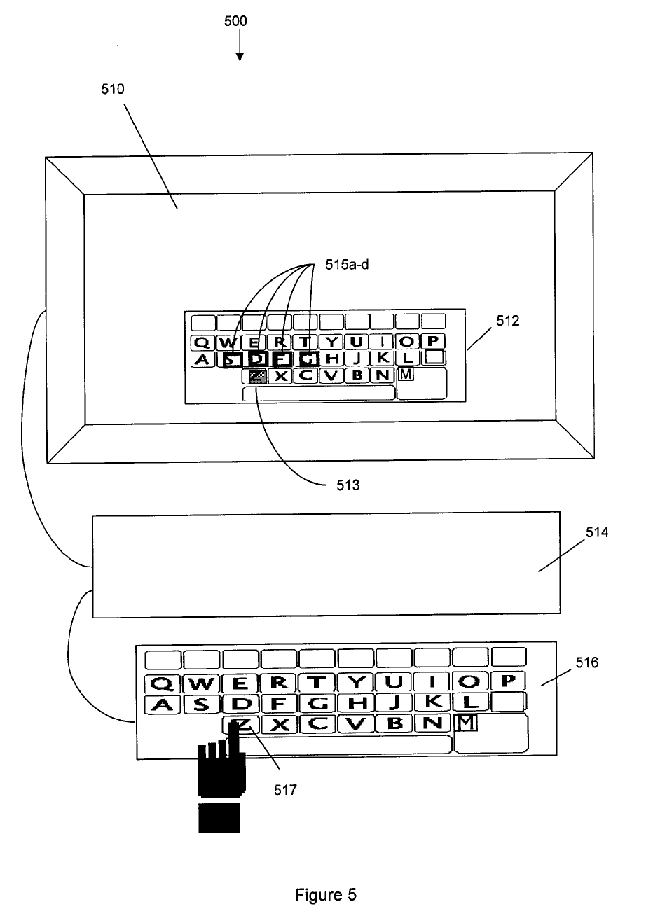

Referring to FIG. 5, in another embodiment of the invention the processor 514 can also be configured with an instructional application (e.g., software designed to teach a user to type or play a piano, as applicable) and the image 512 on the display can incorporated into the instructional application to be used as a teaching tool. For example, the processor 514 can be adapted to provide an image 512 on the display 510 that identifies not only the touched keys (see highlighted key 513 illustrating touched key 517), as described above, but also one or more select keys 515a-d on the keyboard 516. A select key can indicate either the next keystroke (i.e., the next key which should be pressed) or can indicate a proper starting position for the user's fingers on the keyboard. The processor 514 can be adapted to contrast the touched keys from the select keys (e.g., by highlighting the touched and selected keys in a different manner, by displaying the touched keys and selected keys in different colors, etc.).

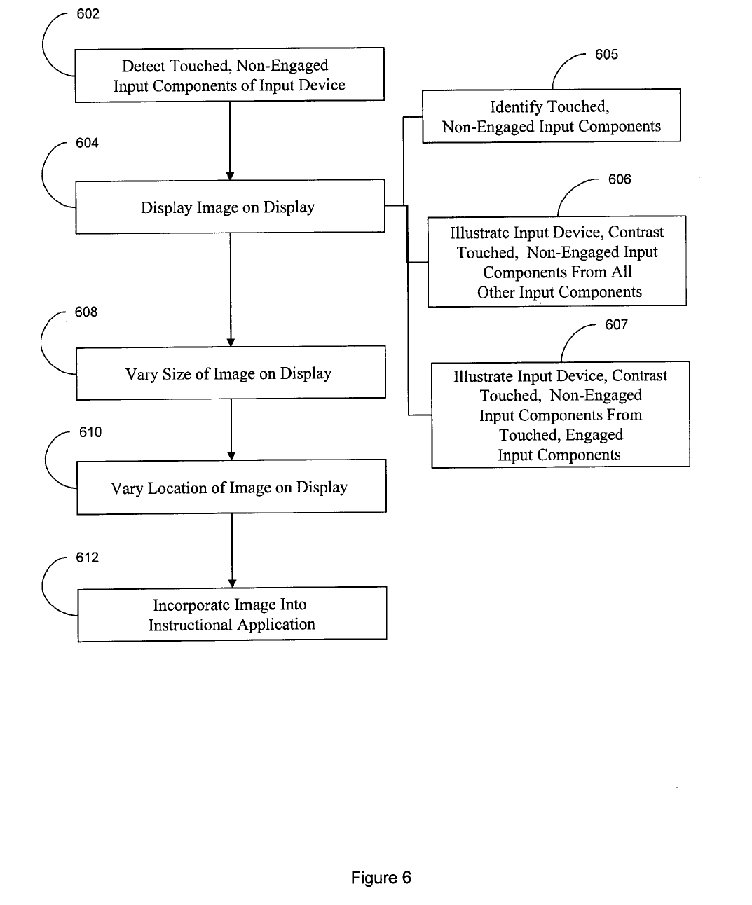

Referring to FIG. 6, an embodiment of the method of the invention for providing visual feedback to a user indicating finger positions on an input device such as, a keypad, a typing keyboard (e.g., a QWERTY keyboard), a musical keyboard instrument (e.g., a digital piano, a synthesizer, etc.), or a control panel comprises detecting touched, non-engaged input components (e.g., keys, buttons, dials, etc.) on an input device (602); and, dynamically displaying on a display (e.g., a display screen of a monitor or a HUD) an image that identifies the touched, non-engaged input components (604). For example, an image can be displayed that includes an illustration identifying only the touched input components (605) or an illustration of the input device that contrasts (e.g., by color, bold outlines, highlighting, etc.) the touched, non-engaged input components with other input components, including touched, engaged input components on the input device (606-607). The method can further comprise varying the location and/or the size of the image on the display (608-610). Additionally, the method can comprise incorporating the image into an instruction application, e.g., a typing or piano instruction application, as discussed above (612).

Therefore, disclosed above is a system and method for providing visual feedback to a user indicating which input components on an input device the user is currently touching in order to avoid engaging the wrong input component. The device comprises a processor connected to both a touch-sensitive input device and a display screen. The touch-sensitive input device is adapted to detect when contact is made with an input component. The processor is adapted to provide an image on a display that dynamically illustrates which input components are currently being touched but not engaged. The processor can further be adapted to allow the user to adjust size and/or location of the image on the display. Lastly, the processor can further be adapted to incorporate the image into an instructional application so it may be used as a teaching tool.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the invention has been described in terms of embodiments, those skilled in the art will recognize that the invention can be practiced with modification within the spirit and scope of the appended claims.

What is claimed is:

1. A system comprising:
a processor;
an input device connected to said processor, wherein said input device comprises a plurality of input components and wherein said input device is adapted to detect touched, non-engaged input components on said input device and to dynamically convey to said processor an indication of said touched, non-engaged input components; and
a display connected to said processor, wherein said processor is adapted to dynamically provide an image on said display that identifies said touched, non-engaged input components.

2. The system of claim 1, further comprising a sensor corresponding to each of said plurality of input components, wherein each sensor is adapted to detect when a finger touches a corresponding input component.

3. The system of claim 1, wherein said image comprises an illustration of said input device highlighting said touched, non-engaged input components.

4. The system of claim 1, wherein said image comprises an illustration of said input device with said touched, non-engaged input components having a different color than other input components on said input device.

5. The system of claim 1, wherein said processor is adapted to allow a user to determine a location of said image on said display.

6. The system of claim 1, wherein said processor is adapted to allow a user to determine a size of said image on said display.

7. The system of claim 1, wherein said input device comprises one of a keypad, a typing keyboard, a musical keyboard instrument, and a control panel.

8. The system of claim 1, wherein said processor is further adapted to contrast on said image touched, non-engaged input components and touched, engaged input components.

9. A system comprising:
a processor having an instructional application;
a keyboard in communication with said processor, wherein said keyboard comprises a plurality of keys and wherein said keyboard is adapted to detect touched, non-pressed keys on said keyboard and to dynamically convey to said processor an indication of said touched, non-pressed keys; and
a display in communication with said processor,
wherein said processor is further adapted to dynamically provide an image on said display that identifies said touched, non-pressed keys and to incorporate said image into said instructional application.

10. The system of claim 9, further comprising a sensor corresponding to each of said plurality of keys, wherein each sensor is adapted to detect when a finger touches a corresponding key.

11. The system of claim 9, wherein said image comprises an illustration of said keyboard that highlights said touched, non-pressed keys, that highlights at least one select key on said keyboard, and that contrasts said touched, non-pressed keys with said at least one select key, and
wherein said at least one select key indicates one of a starting finger position on said keyboard and a location of a next keystroke.

12. The system of claim 9, wherein said processor is adapted to allow a user to determine a location of said image on said display.

13. The system of claim 9, wherein said processor is adapted to allow a user to determine a size of said image on said display.

14. The system of claim 9, wherein said keyboard comprises one of a typing keyboard and a musical keyboard instrument.

15. The system of claim 9, wherein said processor is further adapted to contrast on said image touched, non-pressed keys and touched, pressed keys.

16. A method comprising:
detecting touched, non-engaged input components of an input device; and
dynamically displaying on a display an image that identifies said touched, non-engaged input components.

17. The method of claim 16, wherein said displaying of said image comprises displaying an illustration of said input device that contrasts said touched, non-engaged input components with other input components on said input device.

18. The method of claim 16, wherein said displaying of said image comprises displaying an illustration of said input device with said touched, non-engaged components having a different color than other input components on said input device.

19. The method of claim 16, further comprising varying at least one of a location and a size of said image on said display.

20. The method of claim 16, further comprising incorporating said image into an instruction application.
